(19) United States
(12) Patent Application Publication
(10) Pub. No.: US 2015/0079907 A1
(43) Pub. Date: Mar. 19, 2015

(54) WIRELESS DATA COMMUNICATION BETWEEN A MASTER DEVICE AND A SLAVE DEVICE

(71) Applicant: David Alexandre Engelien-Lopes, Malvik (NO)

(72) Inventor: David Alexandre Engelien-Lopes, Malvik (NO)

(73) Assignee: NORDIC SEMICONDUCTOR ASA, Trondheim (NO)

(21) Appl. No.: 14/344,283

(22) PCT Filed: Aug. 30, 2012
(86) PCT No.: PCT/GB2012/052122

§ 371 Date: Sep. 9, 2014

(30) Foreign Application Priority Data
Sep. 13, 2011 (GB) 1115791.4

(51) Int. Cl. H04W 52/02; H04W 74/06; H04W 4/00

(52) U.S. Cl. CPC H04W 52/0212; H04W 4/008; H04W 74/06
USPC 455/41.2

(57) ABSTRACT

A method of wireless communication between a master device and a slave device is disclosed. The method comprises:
the master device continually transmitting request messages to the slave device;
the slave device transmitting reply messages in reply only to some of said request messages;
   wherein the slave device transmits a reply message in reply to a request message if:
a) a predetermined period has elapsed since it transmitted its last reply message; or
b) the request message contains data.

This invention relates to wireless data communication, particularly, although not exclusively, short-range radio communications.

A number of short-range radio communication protocols are known in which a master device communicates with a peripheral or slave device e.g. to control the peripheral device and/or to send data to or receive data from it. Examples of such protocols are Bluetooth, ANT, Zigbee etc.

One of the issues facing designers of such systems is that there is a trade-off between the responsiveness of peripheral devices and their power consumption and thus battery life. Thus while it is desirable from a user's perspective that a peripheral device responds quickly to a command or data sent by the master, this implies a frequent transmission of signals from the master which gives rise to a high power consumption in the peripheral device as it is typically required to respond to all signals it receives from the master. The power consumption could be reduced by increasing the communication interval but this carries the price that it increases the average time the peripheral device takes to respond to the master's communication messages, known as ‘application latency’, which may be undesirable in some circumstances.

The trade-off is particularly acute in so-called “zero data” links in which data is only sent if there is an event and thus for the majority of the time the peripheral is using power to reply to messages from the master that do not contain any data.

It is known to reduce power consumption in the peripheral device by configuring it to ignore a certain proportion of messages from the master. This is known as ‘slave latency’. For example with a slave latency of three the slave or peripheral device will only listen to and respond to every third message from the master, ignoring the intervening two messages. This reduces average power consumption since the slave device transmits less often and also allows the receiver to be turned off during the intervening transmissions. However it does not assist with the problem set out above since increasing the slave latency will also increase the master's application latency accordingly.

The present invention aims to address this problem and when viewed from a first aspect provides a method of wireless communication between a master device and a slave device comprising:

the master device continually transmitting request messages to the slave device;

the slave device transmitting reply messages in reply only to some of said request messages;

wherein the slave device transmits a reply message in reply to a request message if:

a) a predetermined period has elapsed since it transmitted its last reply message; or

b) the request message contains data.

The invention extends to a system for wireless communication comprising a master device and a slave device wherein:

the master device is arranged continually to transmit request messages to the slave device;

the slave device is arranged to transmit reply messages in reply only to some of said request messages; and

wherein the slave device transmits a reply message in reply to a request message if:

a) a predetermined period has elapsed since it transmitted its last reply message; or

b) the request message contains data.

The invention also extends to a slave device for wireless communication with a master device which continually transmits request messages, the slave device being arranged to transmit reply messages in reply only to some of said request messages; wherein the slave device transmits a reply message in reply to a request message if:

a) a predetermined period has elapsed since it transmitted its last reply message; or

b) the request message contains data.

Thus it will be seen by those skilled in the art that in accordance with the invention, although it may listen to them, the slave or peripheral device does not reply to every request message from the master; rather it waits for a certain period before replying unless the master device has data to send and the request message includes such data. This represents a saving in power consumption as the slave device's transmitter is powered up less often. However it does not compromise the ability of the master device to transmit data, such as command codes, to the slave and have it act on them quickly if required. This effectively allows an increase in the slave latency, and the attendant advantage in terms of reduced slave power consumption, but without a corresponding increase in application latency at the master.

The predetermined period for which the slave device refrains from transmitting a reply could be defined as a time, or as a whole number of request messages which are not replied to. In some embodiments the latter is preferred—e.g. as it more easily adaptable to changes in the transmission interval between request messages.

The predetermined period during which the slave device does not reply could simply be fixed at manufacture, or could be variable. In one set of embodiments the predetermined period is set in response to a command received from the master device. This allows a protocol whereby the master device is able to set the latency period of the slave. The slave may be forced to accept this or may be adapted to apply an algorithm for determining whether to accept the latency period or to reject an initial connection request from the master device. Such a function is beneficial in ensuring that the slave device does not pair with a master device that requires too high an update rate (by setting the predetermined period too short) that the battery life of the slave device is unacceptably low. Of course the actual power consumption will depend to some extent on how often the master sends non-zero-data messages, but the slave latency (the minimum regularity with which the slave must transmit) will have a much bigger effect for a typical zero-data link.

In some embodiments the master device is paired with only one slave; in other embodiments it is paired with multiple slave devices.

In a set of preferred embodiments the slave device is arranged to advertise to a master device that it is able to operate in accordance with the invention. This could, for example, be included in a transmission made by the slave device advertising its availability to form a connection. Although the master device will set the slave latency, it can select a higher slave latency if it detects that the slave is able to operate in accordance with the invention as the master device will know that this will not have such an adverse effect on the application latency compared with a prior art slave device.

In accordance with the invention the slave device will transmit a reply message if it receives a non-zero-data request message from the master or if required by the slave latency setting. However in a set of embodiments the slave device is further configured to send a reply message if the slave device has data to send to the master device. Thus embodiments are envisaged where both the slave and the master both occasionally have time-critical data to transmit. Of course this may be configurable according to the application. In some applications the slave device may be configured to send data only when it is transmitting a reply anyway. This preserves the maximum power saving. Alternatively the slave device may be able to choose whether to send data immediately or with the next mandated transmission according to a priority algorithm. This provides flexibility and the opportunity to transmit data quickly if required.

As mentioned above, although the slave device may listen to every message, this is not essential. Thus in some embodiments the slave device may ignore some request messages without even listening to them. This will dictate the minimum application latency which can be achieved. So for example whilst in some applications an application latency of one is required—in which all request messages are listened to—in other applications a higher application latency may be acceptable. For example an application latency of three would mean that the slave device only listen to every third request message (and only respond to it if it contained data or if the slave latency had been reached). It will be appreciated that the invention allows the slave latency to be higher than the application latency. Clearly an application latency greater than one will have a further beneficial effect in conserving power as it potentially allows even the receiver to be powered down during the transmission of some messages.

Typically the master device would define the application as well as the slave latency.

The invention may be applied to a number of different wireless data protocols—especially those which use zero-data links. Two non-limiting examples include the ANT protocol and Bluetooth Low Energy™.

An embodiment of the invention will now be described, by way of example only, with reference to the accompanying drawings in which:

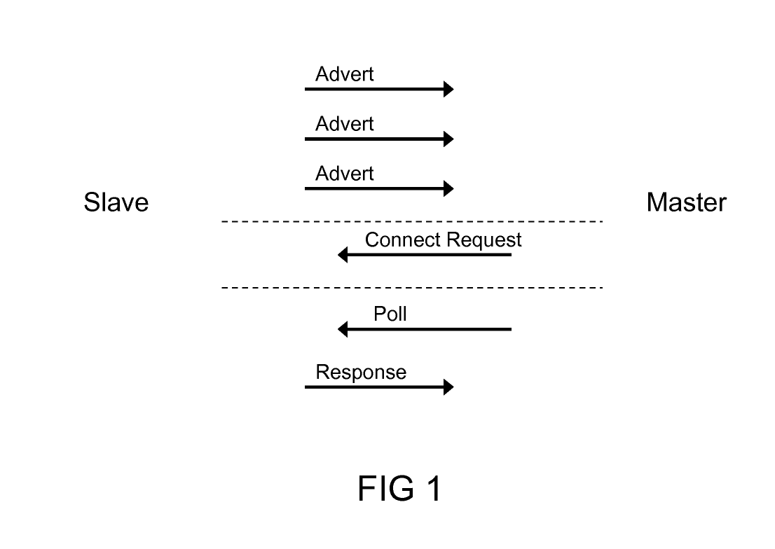

FIG. 1 is a schematic diagram showing the establishment of a link in accordance with an embodiment of the invention;

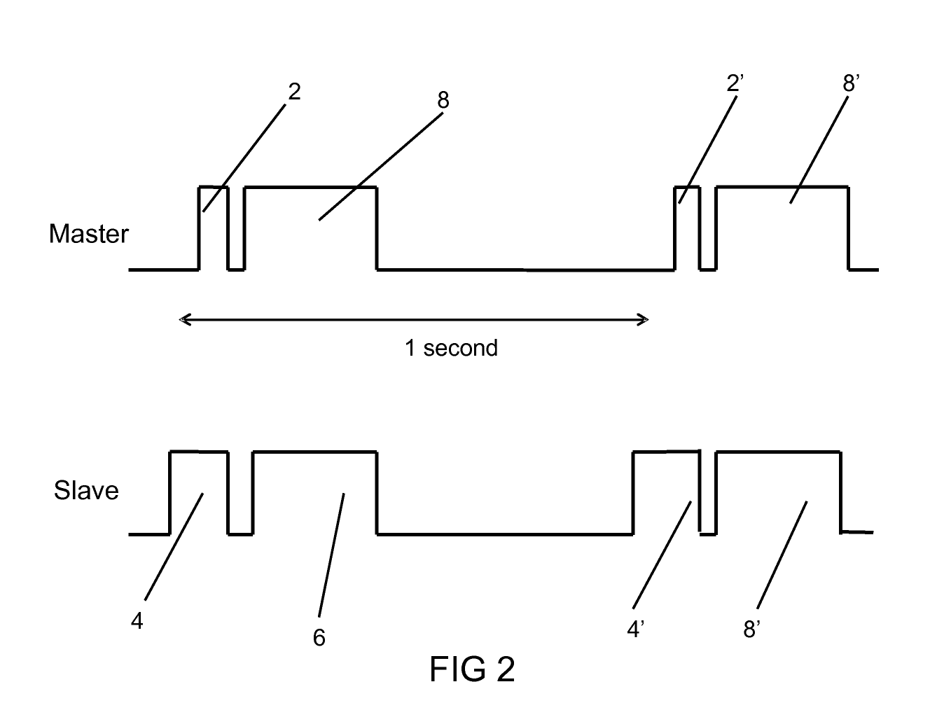

FIG. 2 is a timing diagram showing transmission and receipt of signals by the master and slave once a link has been established; and

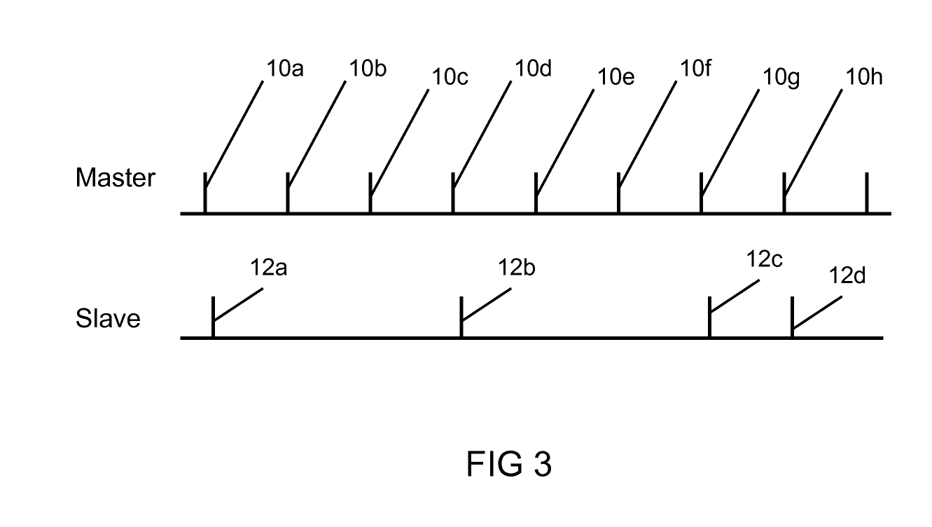

FIG. 3 is a simplified diagram showing transmissions by the master and slave respectively.

FIG. 1 shows the establishment of a data link between a master device and slave device in a wireless data communication protocol such as ANT or Bluetooth Low Energy™. The master device would typically be relatively sophisticated, incorporating at least some form of microcontroller. It could for example be a smart-phone or personal computer. It may be for example battery or mains-power operated. The slave device would typically comprise less processing power and be battery-operated. An example might be a wireless headset.

Moving from the top of the diagram down, in an initial Pre-Link phase the slave device periodically transmits a message ‘Advert’ advertising its availability to connect and listens for a reply. This transmission could be relatively infrequent—say every ten seconds—thereby not draining the slave's battery too much. When the master wishes to form a connection it initiates a Connection phase by replying to one of the Advert messages with a ‘Connect Request’ message. The latter includes information about the nature of the connection that the master wishes to make. It includes for example a parameter setting the interval between polling messages that will characterise the connection. It also includes the slave latency which the slave may observe—that is the maximum number of poll messages from the master device that the slave device can wait since its last response before it responds again. It may further include the application latency—that is the maximum number of poll messages from the master device that the slave device can simply ignore. This sequence is typical of a number of wireless communication protocols. It could for example be Bluetooth Low Energy™.

In a variant of this process (not illustrated) there may be an additional step in which the master interrogates the slave device as to whether it is operable in the way that will be described below. For example a memory on the slave device may include an addressable portion which contains a flag. Another way of achieving this could be through appropriate setting of particular bits in a unique user identification (UUID) code that forms part of the protocol. This might be discoverable automatically—e.g. as part of the Advert message. The link parameters set by the master device might be determined to some extent by whether the slave device is operable in this way. For example, for reasons which will be explained, the master device may be prepared to tolerate a higher slave latency if the slave device is operable in accordance with the invention as this will not have the same impact on the application latency that it is able to set compared to a slave device which is not operating in accordance with the invention.

Once the master has sent the Connect Request message to establish the link, it starts to send Poll messages periodically at the interval specified in the Connect Request message. The slave then replies with a ‘Response’, although not in every case as will be seen with reference to FIG. 3.

FIG. 2 shows in more detail a typical sequence of transmissions between the master and slave while a connection is in place. The master sends a Poll message during a transmit window 2. This coincides with a receive window 4 of the slave which allows the Poll message to be received by the slave. By powering up its radio receiver only for a short time window when the master transmission is expected, the slave device can limit its power consumption and so extend its battery life. The Poll message may contain data or commands for the slave or it may carry null data and simply maintain the connection, which may be necessary depending on the protocol employed.

A short time after receiving the Poll message the slave then powers on its transmitter during a window 6 and transmits a Response message. This too could simply be a null message as required by the protocol or could contain data which the slave is transmitting to the master. The master receives this Response message during a receive window 8. The cycle then repeats with a period of one second. The next master transmit and receive windows 2′, 8′ and corresponding slave receive and transmit windows 4′, 6′ are shown on the right hand side of FIG. 2.

It will be observed that the master receive window 8, 8′ is significantly longer than the slave transmit window 6, 6′. This reflects the fact that the master can be linked to a plurality of slaves simultaneously so that each replies within a given timeslot.

Turning now to FIG. 3, there may be seen schematically a series of Poll messages 10a-h from the master (e.g. at one second intervals as before) and corresponding Response messages 12a-d from the slave. However it may be seen that not every Poll message 10 receives a Response message 12. The reflects the fact that in establishing the link, the master device has set the slave latency, in this example, to be three. This means that the slave is permitted, in order to conserve power, to ignore up to two consecutive Poll messages 10 from the master, only responding to the third. Thus as can be seen here the first Poll message 10a prompts a response 12a but the next two 10b, 10c are ignored. The following Poll message 10d is however responded to by 12b since the slave latency limit has been reached. The same pattern then repeats with two Poll messages 10e, 10f being ignored and the following one 10g being responded to by 12c. However rather than the subsequent Poll message 10h being ignored, it too is responded to by a Response message 12d. This is because the Poll message 10h contained data and/or commands for the slave. The subsequent Response message 12d could for example act as an acknowledgement of safe receipt of the data/command.

It will be seen that although this embodiment requires the slave receiver to be powered up in every cycle, thereby obviating some of the advantage of setting a high slave latency, it means that the slave latency can indeed be set relatively high without having an adverse impact on the application latency. As can be seen from the example above, the slave latency is three, but the application latency can be set at one since the slave listens to every request message allowing it to respond immediately (within standard system response times) to the non-zero-data Poll message 10h—i.e. there was no delay introduced as a result of the higher slave latency. Nonetheless the slave latency can still have a beneficial effect on the battery life of the slave since the transmitter does not need to be powered on in each cycle. This system is beneficial in a zero-data link where the typical master packet does not contain any data.

Of course the specific details given here are only exemplary and may be selected to suit any particular application. In particular an application latency greater than one can be set (up to the value of the slave latency).

1. A method of wireless communication between a master device and a slave device comprising:
the master device continually transmitting request messages to the slave device;
the slave device transmitting reply messages in reply only to some of said request messages;
wherein the slave device transmits a reply message in reply to a request message if:
a) a predetermined period has elapsed since it transmitted its last reply message; or
b) the request message contains data.

2. A method as claimed in claim 1 wherein the predetermined period comprises a whole number of request messages.

3. A method as claimed in claim 1 comprising setting the predetermined period in response to a command received from the master device.

4. A method as claimed in claim 1 wherein said master device is paired with multiple slave devices.

5. A method as claimed in claim 1 wherein the slave device advertises to the master device that it is able to operate in accordance with any preceding claim.

6. A method as claimed in claim 5 wherein said slave device advertises to the master device that it is able to operate in accordance with any preceding claim by including information in a transmission made by the slave device advertising its availability to form a connection.

7. A method as claimed in claim 1 wherein the slave device sends a reply message if the slave device has data to send to the master device.

8. A system for wireless communication comprising a master device and a slave device wherein:
the master device is arranged continually to transmit request messages to the slave device;
the slave device is arranged to transmit reply messages in reply only to some of said request messages; and
wherein the slave device transmits a reply message in reply to a request message if:
a) a predetermined period has elapsed since it transmitted its last reply message; or
b) the request message contains data.

9. A system as claimed in claim 8 wherein the predetermined period comprises a whole number of request messages.

10. A system as claimed in claim 8 wherein the slave device is arranged to set the predetermined period in response to a command received from the master device.

11. A system as claimed in claim 8 wherein said master device is able to pair with multiple slave devices.

12. A system as claimed in claim 8 wherein the slave device is arranged to advertise to the master device that it is able to operate in accordance with claim 1.

13. A system as claimed in claim 12 wherein said slave device is arranged to advertise to a master device that it is able to operate in accordance with claim 1 by including information in a transmission made by the slave device advertising its availability to form a connection.

14. A system as claimed in claim 8 wherein the slave device is arranged to send a reply message if the slave device has data to send to the master device.

15. A slave device for wireless communication with a master device which continually transmits request messages, the slave device being arranged to transmit reply messages in reply only to some of said request messages; wherein the slave device transmits a reply message in reply to a request message if:
a) a predetermined period has elapsed since it transmitted its last reply message; or
b) the request message contains data.

16. A device as claimed in claim 15 wherein the predetermined period comprises a whole number of request messages.

17. A device as claimed in claim 15 arranged to set the predetermined period in response to a command received from the master device.

18. A device as claimed in claim 15 arranged to advertise to the master device that it is able to operate in accordance with claim 1.

19. A device as claimed in claim 18 arranged to advertise to the master device that it is able to operate in accordance with claim 1 by including information in a transmission made advertising its availability to form a connection.

20. A device as claimed in claim 8 arranged to send a reply message if it has data to send to the master device.
